(19) United States
(12) Patent Application Publication
(10) Pub. No.: US 2012/0118842 A1
(43) Pub. Date: May 17, 2012

(54) DECELERATED HINGE STRUCTURE FOR A FURNITURE, WITH A FOLDABLE SHELF

(75) Inventor: Luciano Salice, Carimate (Como) (IT)

(73) Assignee: AUTURO SALICE S.P.A., Novedrate (IT)

(21) Appl. No.: 13/142,569

(22) PCT Filed: Sep. 21, 2010
(86) PCT No.: PCT/EP10/63867

§ 371 Date: Jun. 28, 2011

(30) Foreign Application Priority Data
Oct. 13, 2009 (IT) MI2009A 001742

(51) Int. Cl. E05D 11/10; E05D 3/14; A47B 96/02; E05F 5/10

(52) U.S. Cl. 211/144; 16/319; 16/321

(57) ABSTRACT

The hinge structure for a furniture with a foldable shelf (1) reversibly turnable downwards from a closing position of the furniture to a substantially horizontal opening position comprises a first and a second rocker arm (2, 3) hinged at their ends by means of a first, second, third and fourth pin (4, 5, 6, 7) to a first plate (8) able to be fixed to a stationary portion (9) of the furniture and to a second plate (10) able to be fixed to the shelf (1), first decelerating means (11) mainly of the final portion of the opening stroke of the shelf (1) independently from second decelerating means (12) mainly of the initial portion of the opening stroke of the shelf (1).

The present invention refers to a decelerated hinge structure for a furniture, with a foldable shelf.

A type of furniture with a foldable shelf is known, reversibly turntable downwards from a closing position of the furniture to a substantially horizontal opening position.

In this type of furniture, the hinge with which the shelf is articulated to the fixed portion of furniture comprises a pair of rocker arms hinged at one of their ends to the fixed portion of the furniture and at the other of their ends to the shelf.

The hinge also has a decelerating device which serves to slow down the opening of the shelf by contrasting its falling effect by gravity.

One of the main drawbacks lamented by many of decelerated hinges for this type of furniture consists in that the decelerating device intervenes just in the final portion of the opening stroke which therefore proceeds in an extremely irregular way, initially too rapid and slowed down only subsequently.

To obviate this drawback, in other types of hinges for this kind of furniture, the decelerating device of the kind developing a sliding friction is active during the entire opening stroke of the shelf, but it is necessarily subjected to a rapid wear after a certain number of operating cycles. Furthermore, due to the fact that during the opening stroke the moment due to the weight force varies with respect to the displacement of the centre of gravity of the shelf, in decelerated hinges of this and of other types, interruption conditions for the shelf at certain positions can arise, so forcing the user to intervene manually in order to push the shelf towards the complete opening or closing position.

The technical aim of the present invention is therefore to realize a decelerated hinge structure for a foldable shelf of a furniture, which permits to eliminate the technical drawbacks lamented by the known technique.

Within this technical aim a scope of the invention is to realize a decelerated hinge structure for a foldable shelf of a furniture, permitting a regular and noiseless opening during the entire oscillation arc of the shelf.

Another aim of the invention is to realize a decelerated hinge structure for a foldable shelf, able to preserve during the time and in the most efficient way from the wear its constitutive parts, with a particular reference to those of the deceleration system,

A further aim of the invention is to realize a decelerated, hinge structure for a foldable shelf of a furniture which would result extremely compact.

Not a last aim of the invention is to realize a decelerated hinge structure for a foldable shelf of a furniture able to be easily accessible and inspectable in all its parts.

The technical aim, and also these and other aims according to the present invention are reached by realizing a decelerated hinge structure for a foldable shelf of a furniture according to claim 1.

In the hinge structure according to the invention, the braking action on the shelf is delegated to mutually independent and separate decelerating means, the ones able to mainly intervene in the initial portion of the opening stroke of the shelf and the others in the final portion of the opening stroke of the shelf.

The doubling of the decelerating device permits to reduce the wear effect, as the first and second decelerating means mainly work during a single portion of the opening stroke.

Consequently the opening stroke can become regular even without entailing an excessive wear of the decelerating system.

The doubling of the decelerating system also permits to better calibrate the decelerating action during the opening stroke of the shelf, due to the fact that suitable decelerating means are dedicated to each initial and final portion of the opening stroke of the shelf.

This contributes also to avoid the risk of occurring stall conditions for the shelf during its stroke.

Other features of the present invention are also defined in the subsequent claims.

Further features and advantages of the invention will be more evident from the description of a preferred but not exclusive embodiment of the decelerated hinge structure for a furniture with a foldable shelf according to the finding, and will be shown in an indicative and not limited way in the annexed drawings, in which:

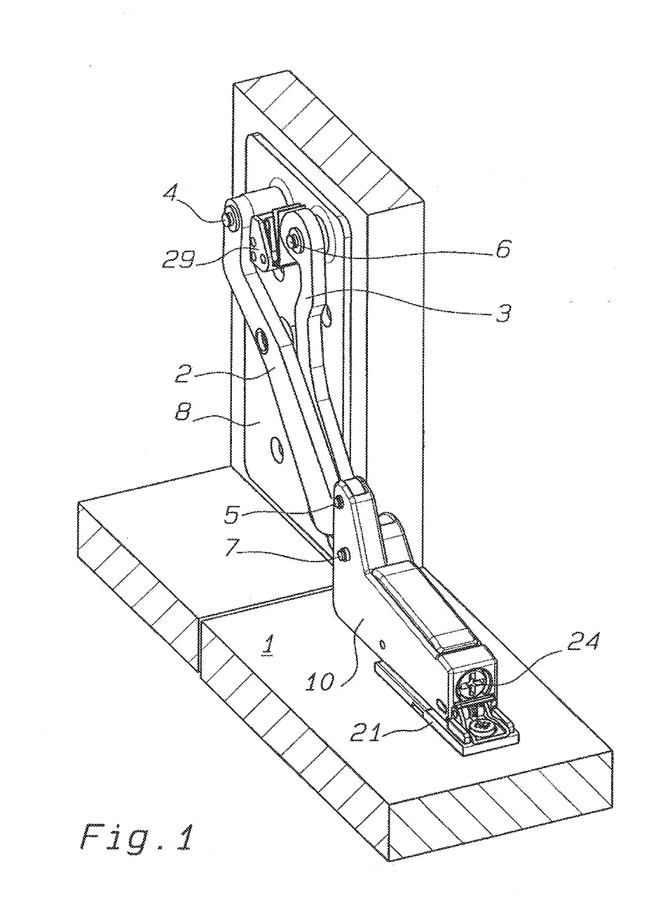

FIG. 1 shows a perspective view of a decelerated hinge structure for a furniture with a foldable shelf in the opening position, according to a preferred way of realizing the invention;

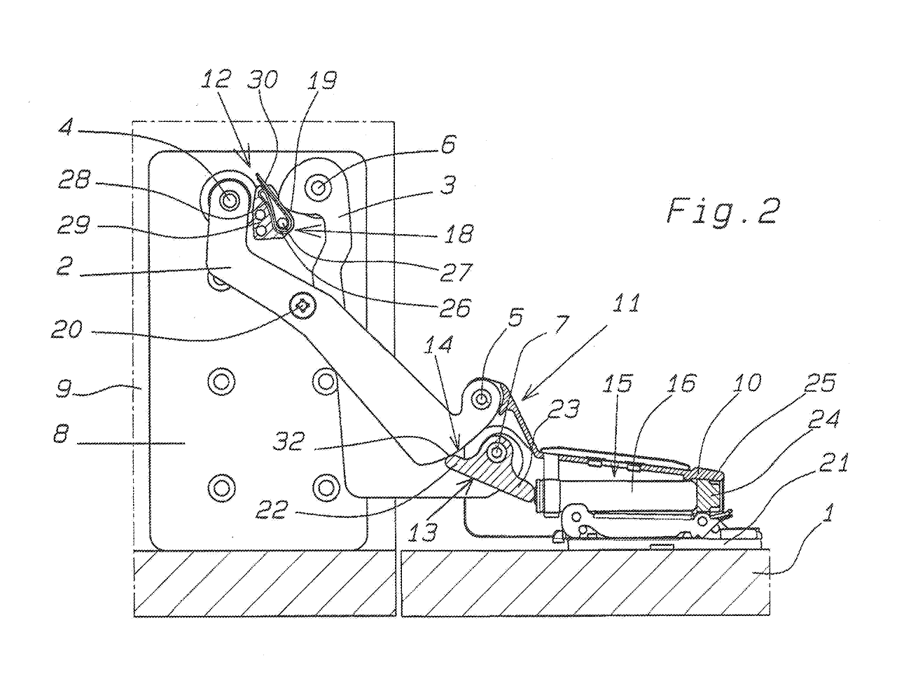

FIG. 2 shows a sectional side elevation view of the hinge structure of FIG. 1 always in the opening position of the shelf; and

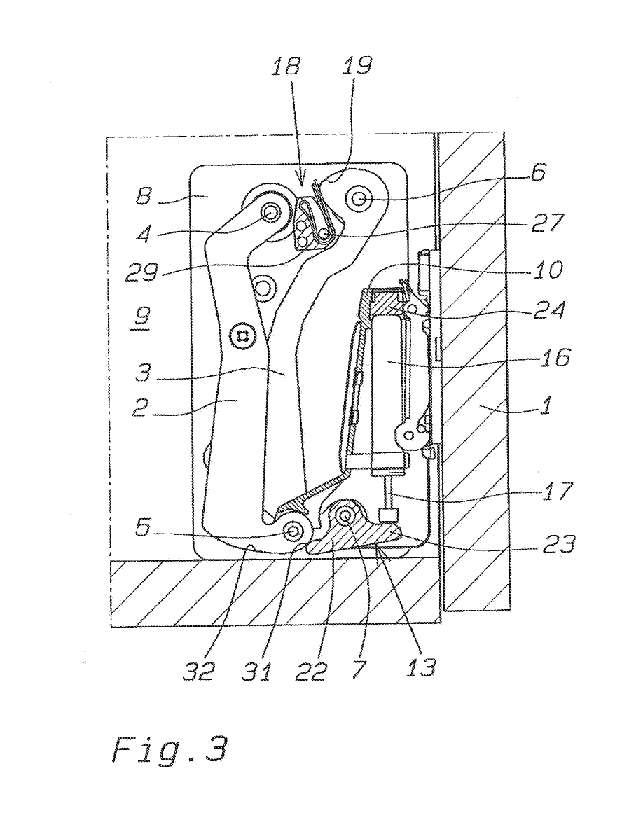

FIG. 3 shows a sectional side elevation view of the hinge structure of FIG. 1 in the closing position of the shelf.

With reference to the cited Figures, a decelerated hinge structure for a furniture with a foldable shelf 1 is shown, reversibly burnable downwards from a closing position of the furniture to an opening substantially horizontal position.

The hinge structure comprises a first rocker arm 2, hinged by a first pin 4 to a first plate 8, able to be fixed to a stationary portion 9 of the furniture, for example to the internal side of the furniture, and by a second pin 5 to a second plate 10 able to be fixed to the shelf 1.

The second plate 10 is fixed in particular to a clip base 21 of a known type, present on the internal side of the shelf 1.

The hinge structure also comprises a second rocker arm 3, hinged by a third pin 6 to the first plate 8 and by a fourth pin 7 to the second plate 10.

The first plate 8 is integral with the stationary portion 9 of the furniture, the second plate 10 is made integral with the shelf 1 and the first and second rocker arm 2 and 3 connecting them form all together an articulated quadrilateral.

According to a particular advantageous aspect of the invention, the decelerated hinge structure comprises first decelerating means 11, mainly of the final portion of the opening stroke of the shelf 1, independent, from second decelerating means 12, mainly of the initial portion of the opening stroke of the shelf 1.

The first decelerating means 11 comprise an oscillating lever 13 engaged from, one side with a first cam 14 present on the first rocker arm 2, and from, the other side with a fluid decelerator 15 fixed to the second plate 10.

The first cam 14 has an active length 32 with a radius of curvature which rapidly differs from the second pin 5 with which the end of the first rocker arm 2 is hinged to the second plate 10.

The oscillating lever 13 is able to receive the movement from the first cam 14 such to actuate in turn the fluid decelerator 15.

The oscillating lever 13 has in particular a first lever arm 22 with a rounded end engaging against the first cam 14 and a second lever arm 23 with a suitably profiled end engaging with the fluid decelerator 15.

In the shown solution, the oscillating lever 13 is hinged just with the fourth pin 7 with which the second rocker arm 3 is hinged to the second plate 10.

The second plate 10 has preferably a box configuration, such to house inside it the fluid decelerator 15, the oscillating lever 13 and the ends or the first and second rocker arms 2 and 3, hinged with the pins 5 and 7.

Naturally the second plate 10 has a window structure through which the first and second rocker arms 2 and 3 and the first lever arm 22 of the oscillating lever 13 extend and move freely.

Preferably the fluid decelerator 15 comprises a cylinder 16, having a sliding piston 17.

In this case the rounded end of the second lever arm 23 of the first cam 14 engages against the piston head 17 for its actuation.

In any case a fluid decelerator of another type, for example a rotating one with a pinion engaging with a rack, can also be considered.

The cylinder 16 is placed at the edge of the shelf 1 with an axis parallel to the shelf 1 and to the rotation plane of the shelf 1. The cylinder 16 can also be regulated in a position along its axial direction by a regulating screw 24 which works at its base.

From the housing 25 provided on the second plate 10 for the regulating screw 24, the cylinder 16 is advantageously reachable for its inspection and/or removal.

The second decelerating means 12 comprise an elastic element 18, which can be deformed by action and in contrast with a second cam 19, present on the first or second rocker arms 2, 3.

In the shown solution, the second cam 19 is present at the end of the second rocker arm 3 and is hinged by the third pin 6 to the first plate 8.

The elastic element 1.8 is a flexion spring of the laminated type (as shown) or even of the wire type.

The flexible spring has a central portion 26, wound around an oscillating pin 27 fixed to the first plate 8, a first spring arm 28 fixed and positioned against a support 29 fixed to the first plate 8, and a second spring arm 30 oscillating around the oscillating pin 27.

The hinge structure is completed by a stop 20 present on one of the rocker arms 2, 3 and able to interfere with the other one between the first, and second rocker arms 2, 3 at the opening position of the shelf 1 in order to block the same in position.

In the known solution the stop 20 is provided on the first rocker arm 2 and is formed by a latch laterally protruding from a side of the first rocker arm 2 in order to interfere with the trajectory of the second, rocker arm 3.

The working of the decelerated hinge according to the invention is evident from which was here described and shown and in particular is substantially the following.

In the closing position of the shelf 1 (FIG. 3) the second cam 19 slightly deforms the elastic element 18 which reacts by transmitting to the second rocker arm 3 an elastic force having a finite force arm with respect to the hinge pin 6 of this. The mechanical torque to which the second rocker arm 3 is subjected acts in the rotation direction (clockwise in FIG. 3) opposed to the opening of the shelf 1. Therefore such mechanical torque contributes to fixedly block the shelf 1 in the closing position.

The second cam 19, during the initial portion of the opening stroke of the shelf 1, noticeably deforms the elastic element 18 which reacts by noticeably increasing the elastic force transmitted to the second rocker 3 with a force arm with respect to the hinging pin 6 of the same, which does not vary in a noticeable way. In this condition the second decelerating means progressively increases the braking action on the shelf 1.

In the same time the first arm 22 of the oscillating lever 13 slides along a substantially neutral length 31 of the first cam 14. The substantially neutral length 31 of the first cam. 14 is substantially conformed as in an arc centered on the pin 5. The lever 13 cannot therefore be placed in rotation and the piston 17 remains in the complete extraction position from the cylinder 16. The braking action due to the first decelerating means is therefore practically zero during the initial portion of the opening stroke of the shelf 1.

By proceeding with the opening stroke of the shelf 1, on the other way the speed with which the deformation of the elastic element 18 increases, becomes noticeably lower than the speed with which the arm of the elastic force reduces itself with respect to the pin 6, with the consequence that the braking action due to the second decelerating means rapidly decreases.

At the same time the first arm 22 of the oscillating lever 13 also slides along the active length 32 of the first cam 14. Due to the fact that, the radius of curvature of the active length 32 of the first cam 14 rapidly differs from the pin 5, the displacement transmitted to the lever 13 noticeably increases and so consequently the contrasting push exerted on the second arm 23 of the lever 13 from the head 17 of the piston also increases.

The retraction sliding of the piston 17 in the viscous fluid present inside the cylinder 16 determines the braking action on the shelf 1.

Naturally between the base of the piston 17 and the base of the cylinder 16 a return spring (not visible in the FIG.) is interposed, able to be compressed during the opening of the shelf 1 and to be expanded during the closing of the shelf 1 in order to extract again the piston 17 from the cylinder 16.

The hinge structure for a furniture with a foldable shelf so conceived is susceptible of many changes and variations, all comprised within the inventive concept; furthermore all details can be changed with technically equivalent elements.

In practice the used materials, and also the dimensions can be of any kind according to the needs of the state of the art.

1. A hinge structure for a furniture with a foldable shelf (1) reversibly turnable downwards from a closing position of said furniture to a substantially horizontal opening position, comprising a first rocker arm (2) hinged by means of a first pin (4) to a first plate (8) able to be fixed to a stationary portion (9) of said furniture and by means of a second pin (5) to a second plate (10) able to be fixed to said shelf (1), and a second rocker arm (3) hinged by means of a third pin (6) to said first plate (8) and by means of a fourth pin (7) to said second plate (10), characterized in that it has first decelerating means (11) of the final portion of the opening stroke of said shelf (1), and second decelerating means (12) mainly of the initial portion of the opening stroke of said shelf (1), said first and second decelerating means (11, 12,) being independent of one another and each being for mainly operating on a different portion of said opening stroke.

2. The hinge structure for a furniture with a foldable shelf (1) according to claim 1, characterized in that said first decelerating means (11) comprise an oscillating lever (13) engaged from one side with a first cam (14) present on said first rocker arm (2) and from the other side with a fluid decelerator (15) fixed to said second plate (10), said oscillating lever (13) being able to receive the movement from said first cam (14) in order to actuate in turn said fluid decelerator (15).

3. The hinge structure for a furniture with a foldable shelf (1) according to claim 2, characterized in that said oscillating lever (13) is hinged to said fourth pin (7) with which said second rocker arm (3) is hinged to said second plate (10).

4. The hinge structure for a furniture with a foldable shelf (1) according to claim 2, characterized in that said first cam (14) has an active length (32) with a radius of curvature which rapidly differs from said second pin (5) with which an end of said first rocker arm (2) is hinged to said second plate (10).

5. The hinge structure for a furniture with a foldable shelf (1) according to claim 2, characterized in that said fluid decelerator (15) comprises a cylinder (16) having a sliding piston (17) which can be actuated by said second cam (14).

6. The hinge structure for a furniture with a foldable shelf (1) according to claim 5, characterized in that said cylinder (16) has an axis parallel to said shelf (1) and to the rotation plane of said shelf (1) and its rear portion rests against a movable stop, which can be blocked in a longitudinal direction in various positions.

7. The hinge structure for a furniture with a foldable shelf (1) according to claim 2, characterized in that said second decelerating means (12) comprise a deformable elastic element (18) by action or in contrast with a second cam (19) present on said first or second rocker arm (2, 3).

8. The hinge structure for a furniture with a foldable shelf (1) according to claim 7, characterized in that said second cam (19) is present at the end of said second rocker arm (3) hinged by means of said third pin (6)to said first plate (8).

9. The hinge structure for a furniture with a foldable shelf (1) according to claim 7, characterized in that said elastic element (18) is a flexion spring.

10. The hinge structure for a furniture with a foldable shelf (1) according to claim 1, characterized in that one between said first and second rocker arms (2, 3) has a stop (20) able to interfere with the other one between said first and second rocker arm (2, 3) at the opening position of said shelf (1) in order to block it in position.

11. A furniture with a foldable shelf (1) characterized in that it comprises a hinge structure according to claim 1.
